(19) United States
(12) Patent Application Publication
(10) Pub. No.: US 2013/0007610 A1
(43) Pub. Date: Jan. 3, 2013

(54) ELECTRONIC READER AND PAGE FLIPPING METHOD THEREOF

(75) Inventors: HAN-CHE WANG, Tu-Cheng (TW); CHIH-HUA HSU, Tu-Cheng (TW); HAI-SHENG LI, Shenzhen City (CN); FANG-YOU WANG, Shenzhen City (CN); CHIH-SAN CHIANG, Tu-Cheng (TW); KUAN-HONG HSIEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/340,708

(22) Filed: Dec. 30, 2011

(30) Foreign Application Priority Data
Jun. 28, 2011 (CN) 201110176652.7

(51) Int. Cl. G06F 17/00

(52) U.S. Cl. 715/273

(57) ABSTRACT

An electronic reader includes an input unit, a storage unit, a display unit, and a processing unit. The input unit generates a content updating signal in response to user's operation. The processing unit includes a file retrieving module, a mode control module, a block setting module, and a display control module. The file retrieving module retrieves content of an electronic file for displaying on the display screen of the display unit, in response to the content updating signal. The mode control module controls the electronic reader to operate in a refreshing mode in which the display screen is divided into a plurality of predetermined blocks. The block setting module determines one or more blocks. The display control module controls the display unit to update the content at the determined blocks with the corresponding retrieved content by refreshing the determined blocks one after another. A related method is also provided.

### BACKGROUND

1. Technical Field

The present disclosure relates to an electronic reader and a page flipping method thereof.

2. Description of Related Art

In an electronic reader equipped with an electronic paper display (EPD) for reading, the EPD is a high resolution, low frequency (HRLF) display, and provides a stable reflective display technology that uses ultra-low power but is easily read under any lighting condition including direct sunlight. However, the EPD typically has a low frame rate, and usually, when a page flipping command is received in response to a user's input, the whole screen displaying the current page is refreshed at one time. That is, the content updating on the whole screen is carried out in one operation. Thus, image artifacts, generally caused by image ghosting or image lag, may exist when the EPD is refreshed, which affects users' viewing on the EPD.

Therefore, what is needed is an electronic reader and a page flipping method thereof alleviating the limitations described above.

### BRIEF DESCRIPTION OF THE DRAWINGS

The components in the drawings are not necessarily drawn to scale, the emphasis instead being placed upon clearly illustrating the principles of an electronic reader and a page flipping method thereof. Moreover, in the drawings, like reference numerals designate corresponding sections throughout the several views.

FIG. 1 is a block diagram of an electronic reader in accordance with an exemplary embodiment.

FIG. 2 is a flowchart of a page flipping method for electronic devices, such as the one of FIG. 1, in accordance with the exemplary embodiments.

FIGS. 3-5 are schematic diagrams of the electronic reader of FIG. 1, showing the page flipping process, in accordance with an exemplary embodiment.

FIGS. 6-10 are schematic diagrams of the electronic reader of FIG. 1, similar to FIG. 3-5, but showing the page flipping process of another exemplary embodiment.

### DETAILED DESCRIPTION

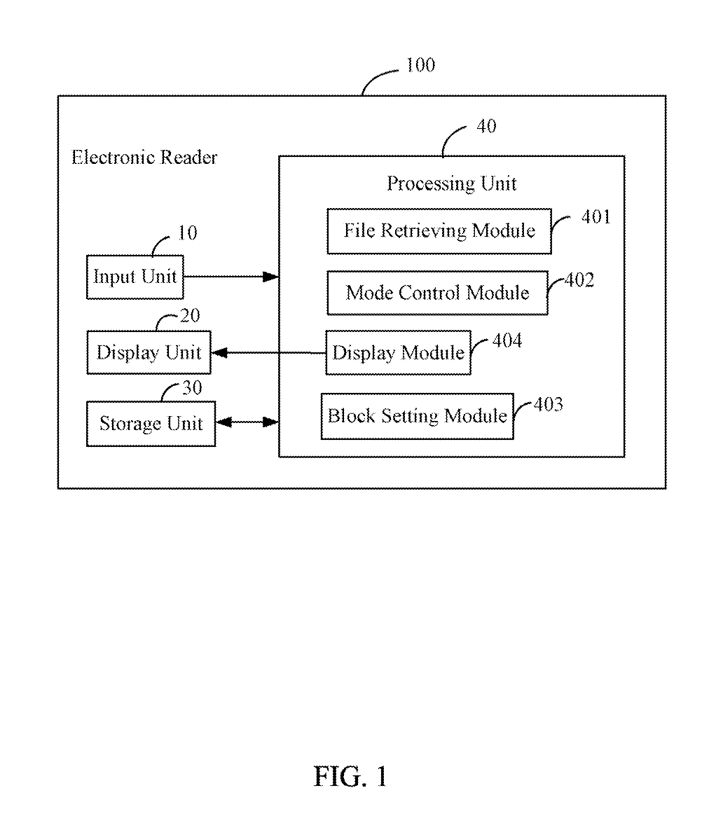

Referring to FIG. 1, an electronic reader 100 is disclosed as an exemplary embodiment. The electronic reader 100 includes an input unit 10, a display unit 20, a storage unit 30, and a processing unit 40.

The input unit 10 is configured to generate a content updating signal in response to user inputs requiring operations such as page flipping, to update the content of the display unit 20, and to transmit signals accordingly to the processing unit 40. The input unit 201 can be a keypad or a touch pad which includes operable function keys such as page up, page down, play, pause, stop, skip, speed, record etc. The function keys of the input unit 201 can be mapped according to actual need.

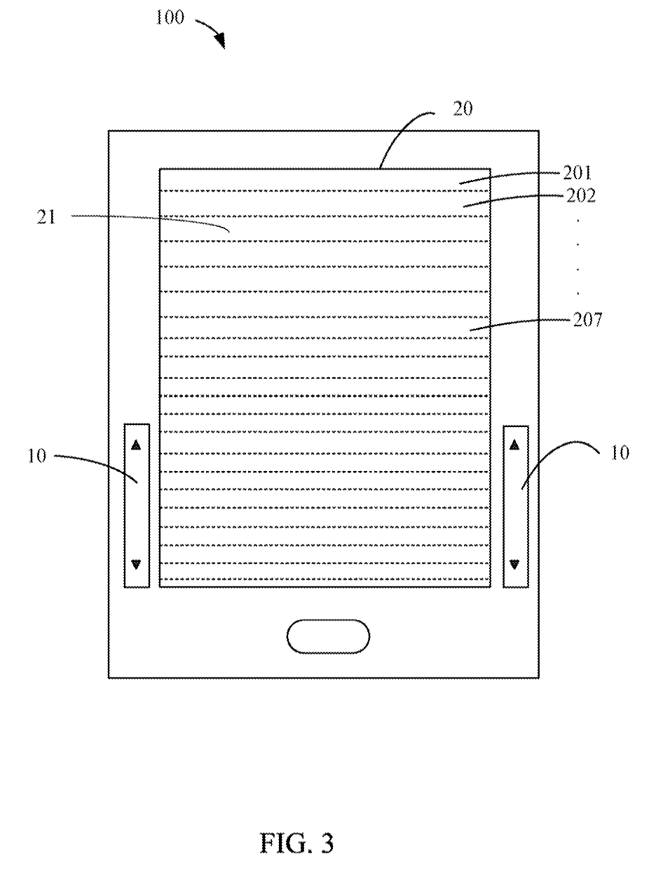

The display unit 20 is an EPD including an electronic paper display screen 21 (See FIG. 3) for displaying content thereon. The storage unit 30 stores a number of electronic files. The processing unit 40 includes a file retrieving module 401, a mode control module 402, a block setting module 403, and a display control module 404.

The file retrieving module 401 is configured to retrieve the content of a target page for displaying on the display screen 21 from the storage unit 30, when a content updating signal is transmitted from the input unit 10.

The mode control module 402 is configured to control the electronic reader 100 to operate in a refreshing mode, when a content updating signal for updating the content of the display unit 20 is transmitted from the input unit 10. In the embodiment, each refreshing mode defines a refreshing direction, and a total number of refreshing blocks successively set corresponding to the refreshing direction. The refreshing directions include from the top of the display screen 21 to the bottom thereof or the reverse, from the left of the display screen 21 to the right thereof or the reverse, and in a clockwise or in a counter-clockwise direction. The refreshing blocks may be rectangular or other predetermined shapes. In the embodiment, when the electronic reader 100 is in a refreshing mode, the refreshing blocks will be refreshed one after another according to the refreshing direction. The default refreshing mode is predetermined by the system, and can also be preset by the user.

The block setting module 403 is configured to determine one or more refreshing blocks where there is the corresponding retrieved content to be displayed. In the embodiment, the block setting module 403 divides the display unit 20 into a number of refreshing blocks as defined in the refreshing mode activated by the mode control module 402. The block setting module 403 also splits the content of the target page into a number of target portions, each target portion mapped and corresponding to a particular refreshing block. In the embodiment, the refreshing blocks have the same size and shape, that is, the display unit 20 is divided into a number of equal parts. Accordingly, the target page mapped to the display unit 20 is also split into the same number of equal parts.

The display control module 404 controls the display unit 20 to update the refreshing blocks one after another with the target portions of the target page appropriately placed in accordance with the refreshing direction defined by the refreshing mode.

In a second embodiment, the storage unit 30 further stores at least one visually indicative effect FIG. 300 for showing the content updating effect such as the page flipping effect on the screen of the display unit 20. An exemplary effect FIG. 300 is a presentation of black and white stripes. Another exemplary effect FIG. 300 may be a blank figure.

During the content updating process of an refreshing block, the display control module 404 firstly invokes one or more effect FIG. 300 from the storage unit 30 to fill the refreshing block. The effect FIG. 300 stay in the refreshing block for a predetermined period of time and then the display control module 404 replaces the effect FIG. 300 with the target portion corresponding to the refreshing block and displays the target portion on the refreshing block. After that, the content updating process of that particular refreshing block is finished and the content updating process moves on to the next immediately following refreshing block. In an alternative embodiment, the content updating process pauses for a short period of time before applying itself to the next refreshing block. As the refreshing blocks are refreshed one after another, the old content on the screen of the display unit 20 is reduced portion by portion to nothing, the effect FIG. 300 are moved from one refreshing block to another in accordance with the refreshing direction, and the new content appears portion by portion on the screen and until finally it has fully replaced the old content.

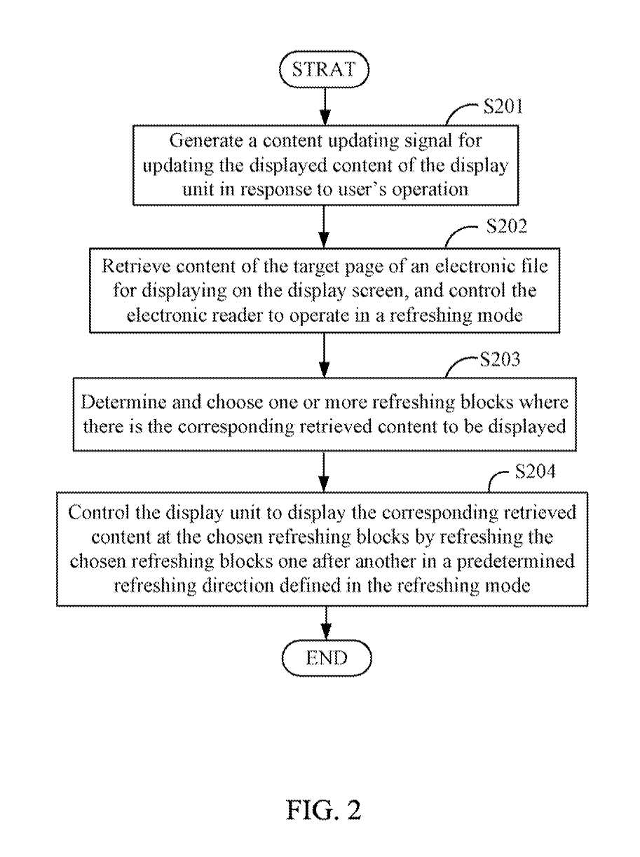

Referring to FIG. 2, a flowchart of a page flipping method of the electronic reader 100 of FIG. 1 is shown. The method includes the following steps, each of which is connected to the various components contained in the electronic reader 100.

In step S201, the input unit 10 generates a content updating signal for updating the displayed content of the display unit 20 in response to user's operation.

In step S202, the file retrieving module 401 retrieves content of the target page of an electronic file for displaying on the display screen 21, and the mode control module 402 controls the electronic reader 100 to operate in a refreshing mode. In the embodiment, each refreshing mode defines a particular refreshing direction, and a total number of refreshing blocks is set successively in accordance with the particular refreshing direction. The refreshing directions may include from the top of the display screen 21 to the bottom thereof or the reverse, from the left of the display screen 21 to right thereof or the reverse, and in a clockwise or a counter-clockwise direction. The shape of the refreshing blocks may be rectangular or another predetermined shape.

In step S203, the block setting module 403 determines and choosing one or more refreshing blocks where there is the corresponding retrieved content to be displayed. In the embodiment, the block setting module 403 divides the display unit 20 into a number of refreshing blocks as defined by the activated refreshing mode, and splits the content of the target page into a number of target portions; each target portion corresponds to a refreshing block and is mapped to the refreshing block.

In step 204, the display control module 404 controls the display unit 20 to display the corresponding retrieved content at the chosen refreshing blocks by refreshing the chosen refreshing blocks one after another in a predetermined refreshing direction defined in the refreshing mode.

Referring to FIGS. 3-5, the page flipping process of the electronic reader 100 in accordance with a first embodiment is shown. In this embodiment, the refreshing mode and the direction associated with it is predetermined by the system, the refreshing order or direction which refreshes the screen is from the top to the bottom. The refreshing mode and associated direction also can be predetermined by the user.

Referring to FIG. 3, the display unit 20 of the electronic reader 100 displays a current page. The input unit 10 generates a page down flipping signal in response to the user pressing the upper portion of the input unit 10. The file retrieving module 401 retrieves the content of the target page (which is the page following the current page), and the mode control module 402 activates the refreshing mode. In accordance with the applicable refreshing mode, the block setting module 403 divides the display unit 20 into a number of consecutive refreshing blocks as illustrated in FIG. 3, which shows a first refreshing block 201, a second refreshing block 202, and a seventh refreshing block 207, until the display area is filled with such refreshing blocks. The block setting module 403 further splits the content of the target page into a number of target portions such as (by way of example only) a first target portion 201′, a sixth target portion 206′, and a seventh target portion 207′.

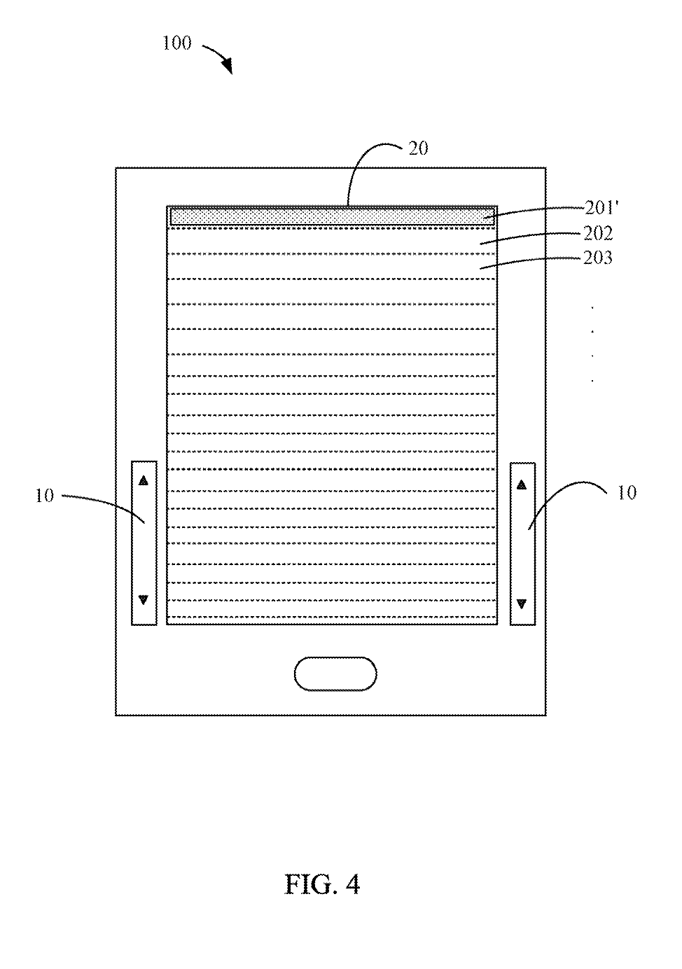

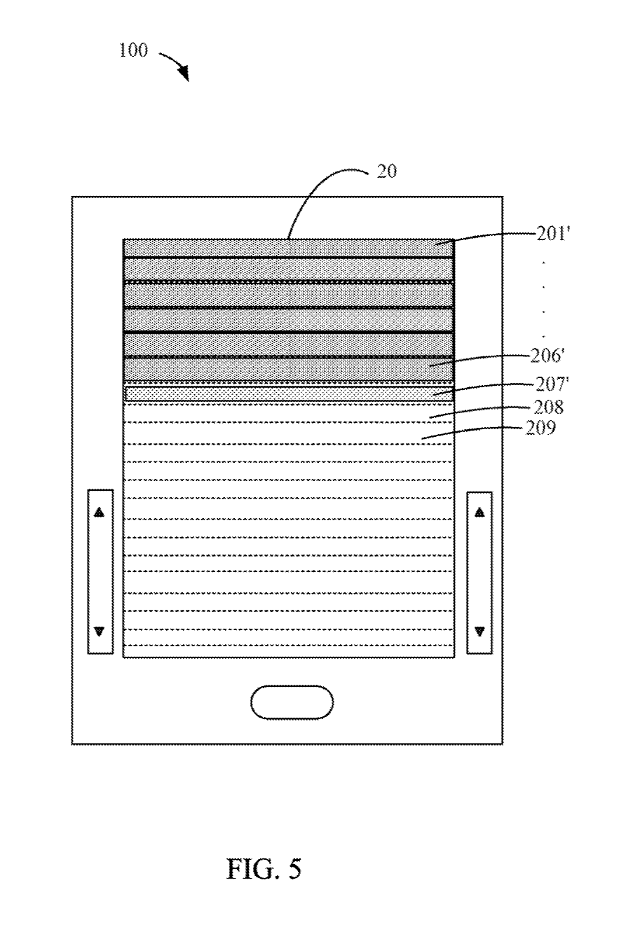

The display control module 404 controls the display unit 20 to update the refreshing blocks one after another, from the top to the bottom, by replacing the current content with the target portions of the target page. In detail, referring to FIG. 4, the display control module 404 updates the first refreshing block 201 of the display unit 20 with the first target portion 201′, while the other refreshing blocks of the display unit 20 continue their current display. The display control module 404 controls the display unit 20 to update the refreshing blocks one after another. Referring to FIG. 5, the refreshing blocks 201-207 are respectively updated with the target portions 201′-207′, while the remaining refreshing blocks display the current page display or part of page display. When all of the target portions of the target page are displayed on the corresponding refreshing blocks of the display unit 20 in place of the previous content, the electronic reader 100 has finished the process for flipping a page.

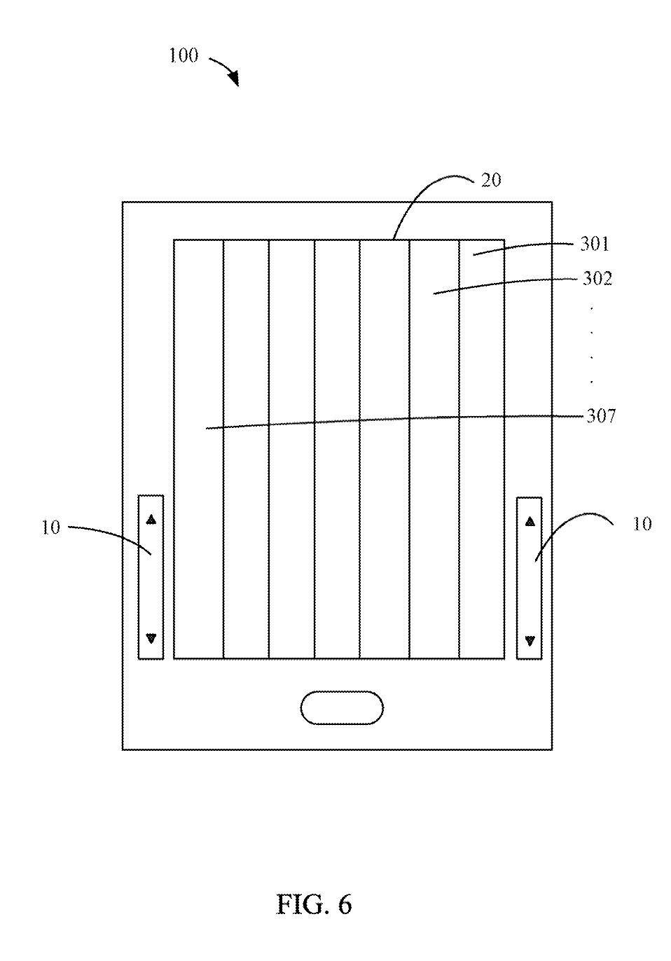

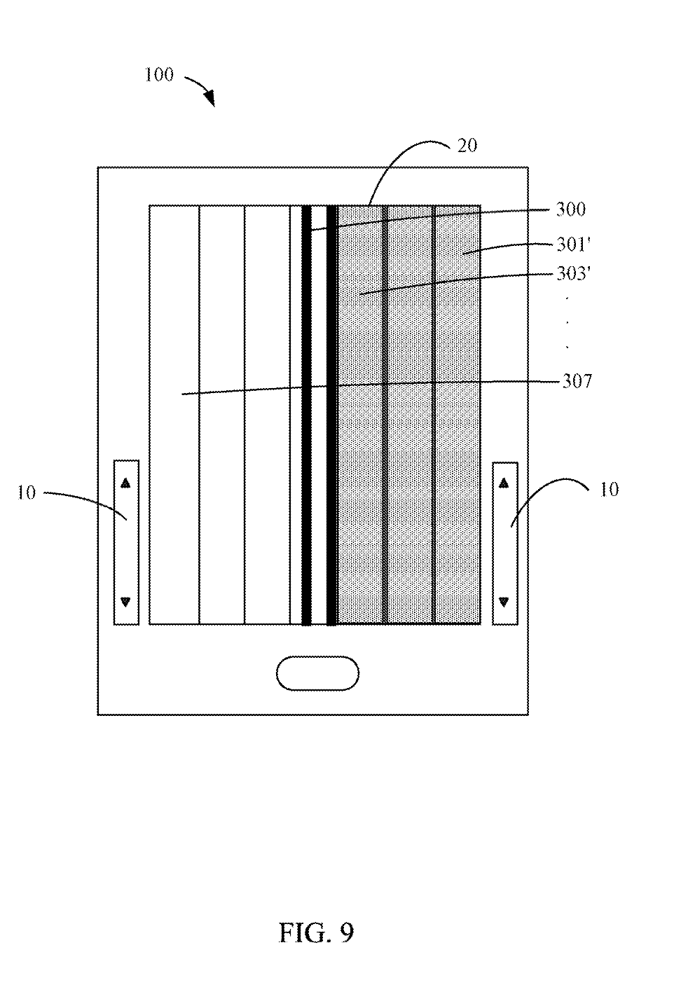

Referring to FIGS. 6-10, the page flipping process of the electronic reader 100 in accordance with a second embodiment is shown. The differences between the second embodiment and the first embodiment are: the default order or direction of the applicable refreshing mode in the electronic reader 100 refreshes the screen of the display unit 20 from right to left, and the storage unit 30 further stores an effect FIG. 300 for displaying the page flipping effect on the screen of the display unit 20. The exemplary effect FIG. 300 is a presentation or image composed of black and white stripes. The refreshing mode also can be predetermined by the user.

Referring to FIG. 6, the display unit 20 of the electronic reader 100 displays the content of a current page. Having been input by a user on the upper portion of the input unit 10, the input unit 10 generates a page down flipping signal. The file retrieving module 401 retrieves the content of the target page, which is the next page following the current page, and the mode control module 402 activates the refreshing mode which requires the refreshing of the screen to be from right to left. The block setting module 403 divides the display unit 20 into a number of refreshing blocks such as a first refreshing block 301, a second refreshing block 302, and seventh refreshing block 307, all as illustrated in FIG. 6. The block setting module 403 further splits the content of the target page into a number of target portions such as a first target portion 301′, a third target portion 303′, and a seventh target portion 307′.

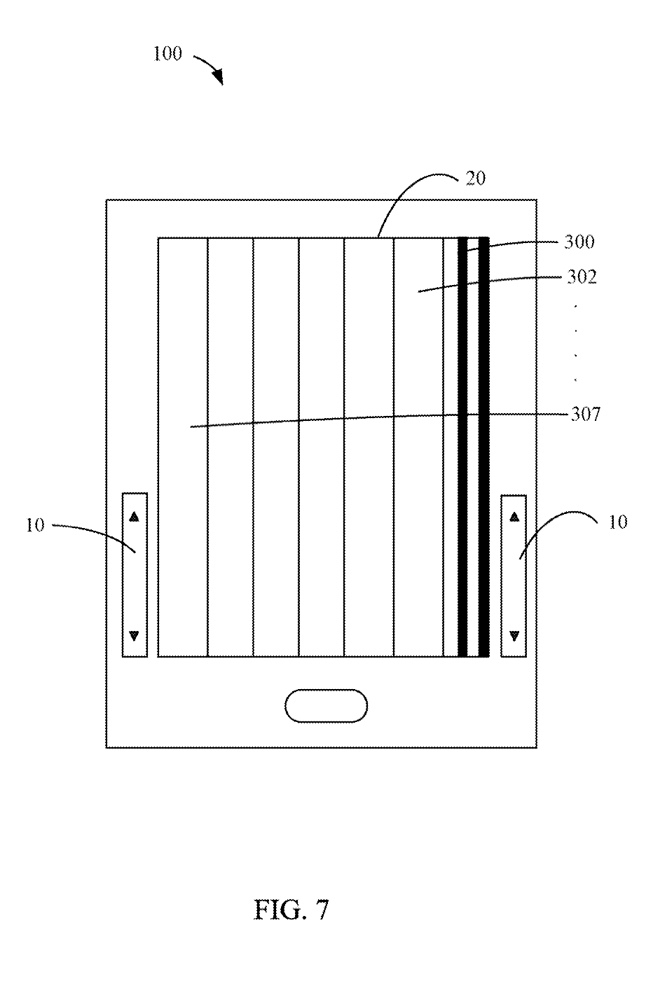

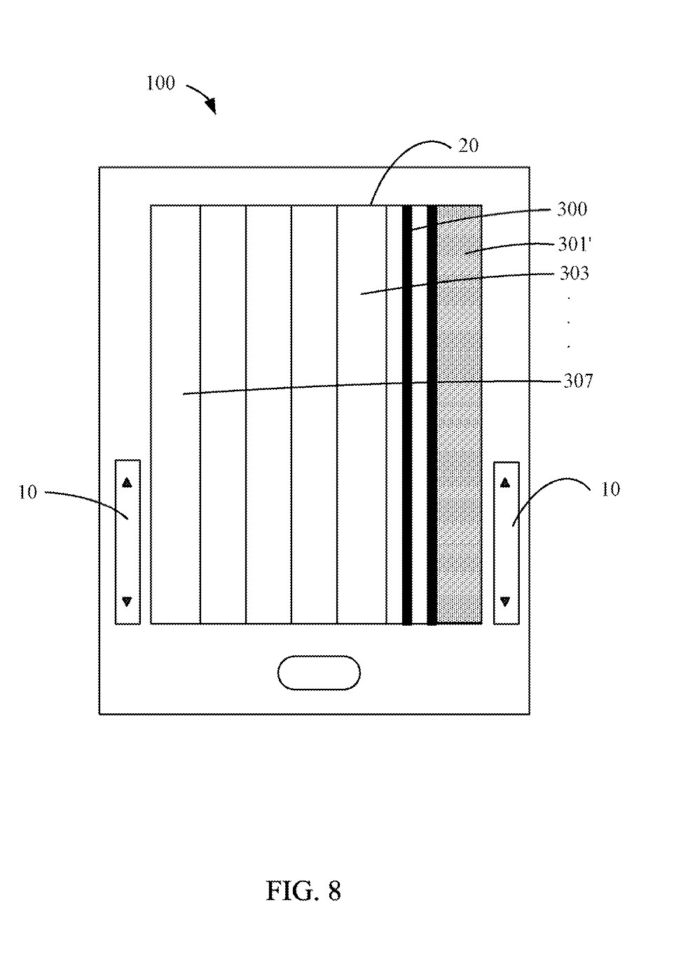

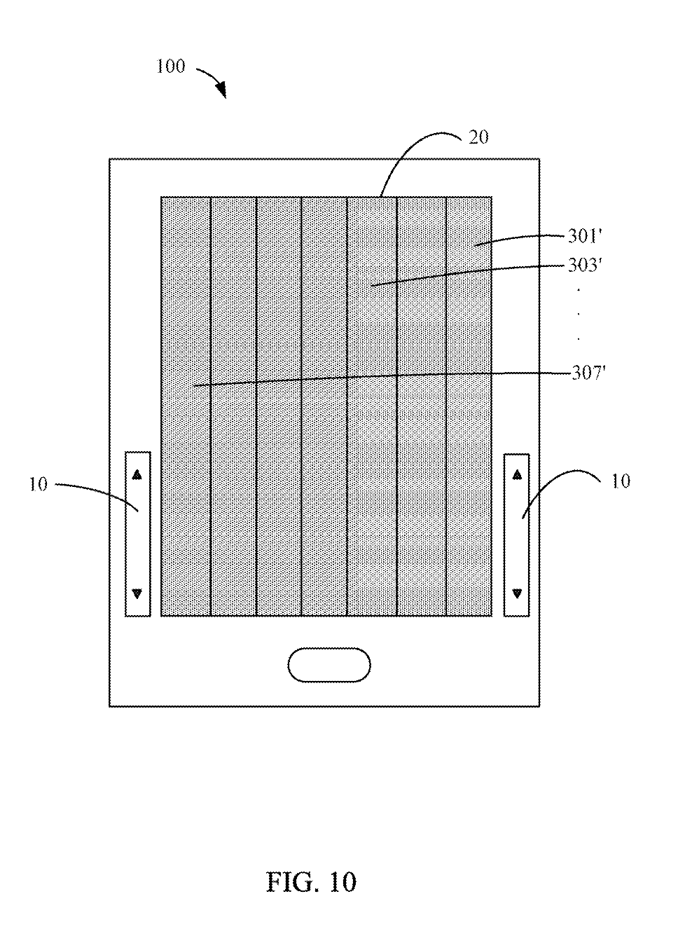

The display control module 404 invokes the effect FIG. 300 from the storage unit 30 to fill the refreshing blocks one after another from right to left. The display control module 404 also displays the effect FIG. 300 in the refreshing block for a predetermined period of time and then replaces the effect FIG. 300 with the target portion corresponding to that refreshing block. In detail, referring to FIG. 7, the display control module 404 invokes the effect FIG. 300 from the storage unit 30 to fill the first refreshing block 301 first. The display control module 404 maintains the display of the effect FIG. 300 in the first refreshing block 301 for a predetermined period of time, while the other refreshing blocks of the display unit 20 maintain their respective current displays. Then the display control module 404 replaces the effect FIG. 300 with the first target portion 301′ in the first refreshing block 301. In this way, the display control module 404 controls the display unit 20 to update the refreshing blocks one after another in a similar manner, so the effect FIG. 300 is displayed in each refreshing block first, and as short intervals of time go by, the effect FIG. 300 appears to move across the display screen from right to left, leaving behind target portions. Referring to FIG. 8, the first refreshing block 301 is updated with the first target portion 301′, the second refreshing block 302 is updated with the effective FIG. 300, and the remaining refreshing blocks continue their display of current content. When all of the target portions of the target page are respectively displayed in corresponding refreshing blocks of the display unit 20 (see FIG. 10), the page flipping process of the electronic reader 100 has been completed.

With such a configuration, the electronic reader 100 provides a vivid page flipping effects to the user, and at the same time, the appearance of screen artifacts is avoided, which gives the user more comfortable viewing.

Although the present disclosure has been specifically described on the basis of the embodiments thereof, the disclosure is not to be construed as being limited thereto.

Various changes or modifications may be made to the embodiments without departing from the scope and spirit of the disclosure.

What is claimed is:

1. An electronic reader comprising:
an input unit configured to generate a content updating signal in response to user's operation;
a storage unit for storing electronic files;
a display unit including a display screen configured to display content thereon; and
a processing unit comprising:
a file retrieving module configured to retrieve content of an electronic file for displaying on the display screen from the storage unit, in response to the content updating signal;
a mode control module configured to control the electronic reader to operate in a refreshing mode in which the display screen is divided into a plurality of predetermined refreshing blocks;
a block setting module configured to determine one or more refreshing blocks where there is the corresponding retrieved content to be displayed; and
a display control module configured to control the display unit to update the content at the determined refreshing blocks with the corresponding retrieved content by refreshing the determined refreshing blocks one after another in a predetermined refreshing direction.

2. The electronic reader as described in claim 1, wherein the refreshing direction is from the top of the display screen to the bottom thereof or the reverse.

3. The electronic reader as described in claim 1, wherein the refreshing direction is from the right of the display screen to the left thereof or the reverse.

4. The electronic reader as described in claim 1, wherein the content updating signal is a page flipping signal.

5. The electronic reader as described in claim 1, wherein the refreshing mode is a default mode.

6. The electronic reader as described in claim 1, wherein the display unit is an electronic paper display device.

7. A page flipping method for an electronic reader, the electronic reader comprising a display unit, the method comprising:
generating a content updating signal for updating the displayed content of the display unit in response to user's operation;
retrieving content of a target page of an electronic file for displaying on the display screen and controlling the electronic reader to operate in a refreshing mode;
determining and choosing one or more refreshing blocks where there is the corresponding retrieved content to be displayed; and
displaying the corresponding retrieved content at the chosen refreshing blocks by refreshing the chosen refreshing blocks one after another in a predetermined refreshing direction.

8. The method as described in claim 7, wherein the content at the non-chosen refreshing blocks is not refreshed and is kept unchanged on the display unit.

9. The method as described in claim 7, wherein the refreshing mode defines a refreshing direction which is from the top of the display unit to the bottom thereof.

10. The method as described in claim 7, wherein the refreshing mode defines a refreshing direction which is from the right of the display unit to the left thereof.

11. The method described in claim 7, wherein the refreshing mode is a default mode.

12. The method as described in claim 7, wherein the display unit is an electronic paper device.
